(19) United States
(12) Patent Application Publication
(10) Pub. No.: US 2011/0119182 A1
(43) Pub. Date: May 19, 2011

(54) Value Transfer System for Online Commerce Using Smart Card and Biometric Reader

(76) Inventor: Sam Smolkin, Hollywood, FL (US)

(21) Appl. No.: 12/872,089

(22) Filed: Aug. 31, 2010

Related U.S. Application Data
(60) Provisional application No. 61/275,492, filed on Aug. 31, 2009.

(51) Int. Cl. G06Q 40/00

(52) U.S. Cl. 705/41

(57) ABSTRACT

A closed value transfer system for online commerce using a Smart Card and a USB Biometric Smart Card and Fingerprint Reader, for making quick, private and secure online purchases.

Applicant hereby claims priority benefit of earlier filed provisional application by the same inventor having Ser. No. 61/275,492 filed on Aug. 31, 2009, which is incorporated herein in its entirety by reference.

Describes a closed system for making quick, private and secure online purchases using two-factor authentication with a smart card and fingerprint biometric reader.

### DESCRIPTION

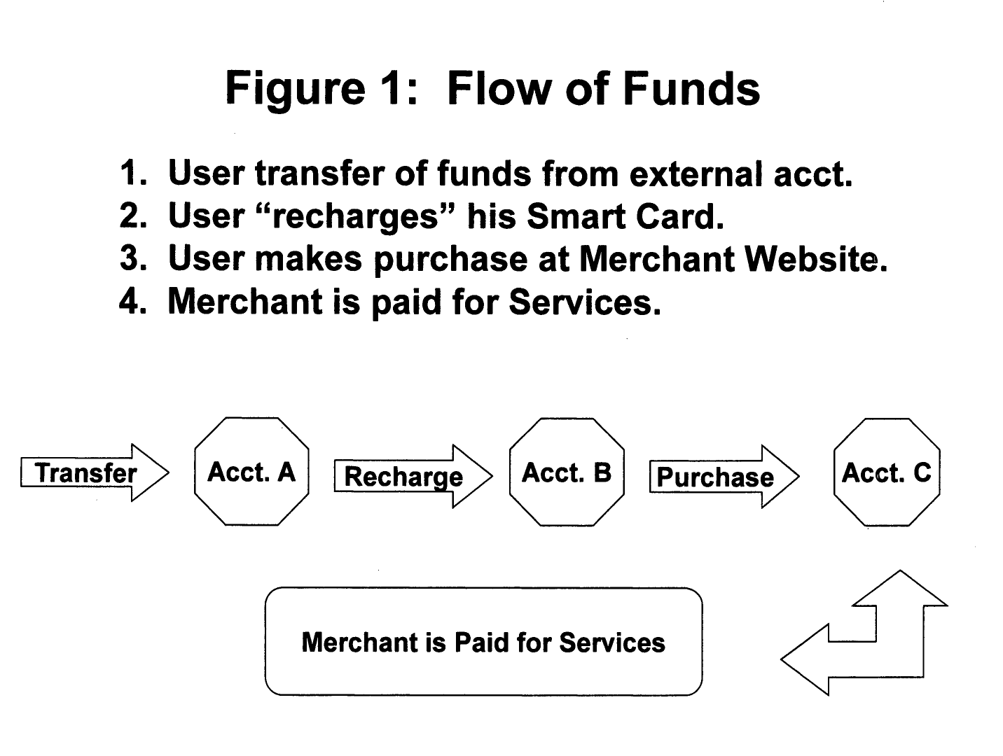

FIG. 1 is representation of flow chart of the system.

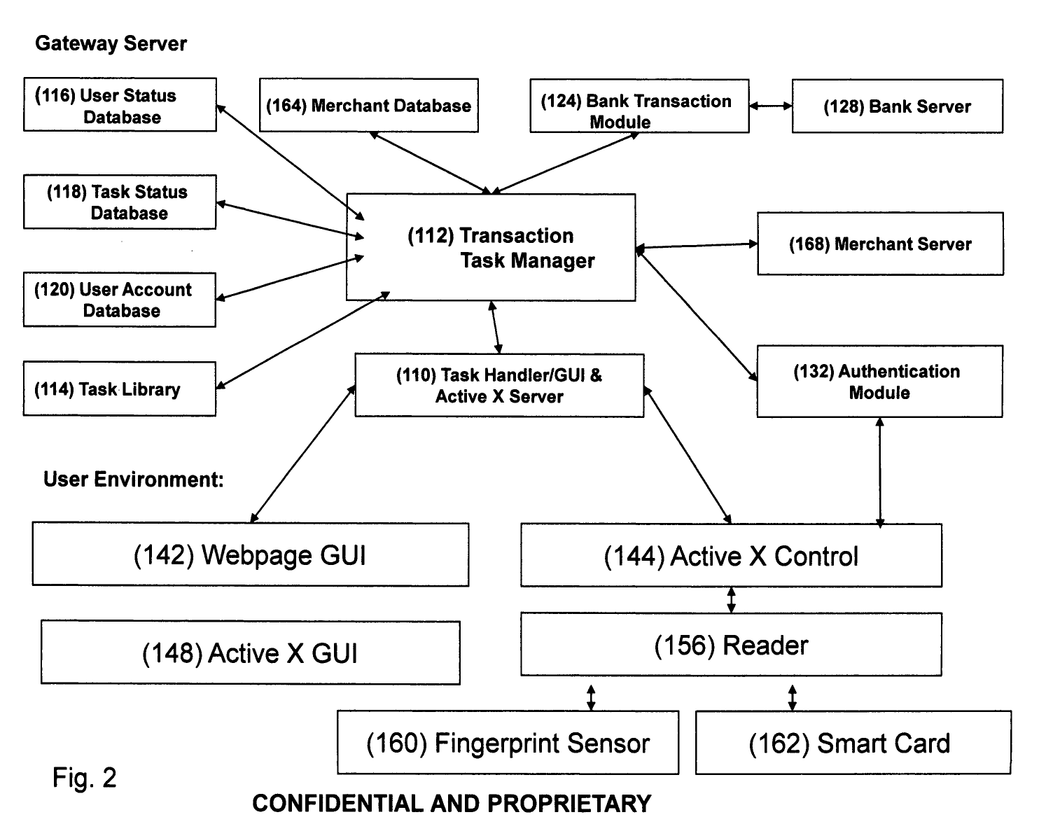

FIG. 2 is example of gateway server and user environment.

The Gateway server is the heart of the system. It provides the user GUI, controls user authentication, movement of funds between accounts during user-initiated money transfers, recharging of the smart card, and online purchases. Through a Gateway website (not necessarily at the same location as the Gateway server), users transfer funds from an external source into a new bank account hosted at a partner bank (herein referred to as user account A). Users add money, or “recharge” their smart card with funds from Account A. During a smart card recharge, the funds are moved by the Gateway server application from Account A to an escrow Account B. The funds of Account A and B are maintained at partner bank. For the purchase at a partner merchant website, users choose to a new payment option called “Pay With Smart Card.” This online purchase is made quick, private and secure by the implementation of a system using a Gateway server application and a smart card reader/biometric device to authenticate the user and debit the user's own funds from his smart card.

### The Use-Cases: Transfer, Recharge and Purchase:

The Gateway application controls either one of the following three user-initiated tasks: Transfer, Recharge and Purchase.

First, in a Transfer, the user transfers funds from an external bank account into his new bank account of Account A.

Second, in a Recharge, the user recharges, or loads, funds from his new Account A into his smart card. The recharged funds are transferred to Account B. In a Recharge, the smart card is not physically recharged with funds. Recharged funds are moved from the user's account A to the user Account B at the bank server. Conceptually to the user, his smart card was recharged. In fact, funds were moved from the Account A to the user Account B.

Third, in a Purchase, the user visits a partner merchant website and chooses to pay with his Smart Card. The merchant website has the necessary interface to the Gateway to confirm that the user has sufficient funds in his Smart Card (actually in his Account B). To complete the purchase, the Gateway informs the merchant website that funds are available. In turn, the Gateway transfer funds into Account C to be later reconciled with the merchant.

### Flow of Funds:

During each Use-Case (Transfer, Recharge and Purchase) actual funds are commanded by the Gateway to move between bank accounts at the partner bank. Diagram 1 shows the flow of funds during a user-initiated Transfer, Recharge and Purchase. The three accounts (A B & C) are maintained at a partner bank. The Gateway application, through a Bank Transaction Module, commands the bank server to move funds between accounts A, B and C. The Gateway maintains its own independent accounting and balances.

In a Transfer, funds are moved by the user from an external source into Account A. In a Recharge, funds are moved from user account (Account A) to smart card account (Account B). After a Purchase, funds are moved from smart account (Account B) to merchant account (Account C).

The final flow of funds, from Account C to the merchant is initiated by the operators of the system when it is time to reconcile funds with each merchant. Note that the direction of the flow of funds may be reversed. For simplicity, the “backward” movement of funds is not shown in Diagram 1. A user may move funds out f his account (Account A) back to his external personal bank. The Transfer would be in reversed. Similarly a reverse-Recharge could occur where the user moves from his smart card (Account B) back into his account (Account A). A merchant may credit a user, the flow of funds would move in reverse of a Purchase, or for Account C to Account B.

### User Experience:

New users sign up for this payment service and receive in the mail the reader/smart card and instructions. User has a smart card reader with an integrated fingerprint application which is plugged into his PC's USB port. The reader has the smart card inserted. The user is also connected to the Internet. The user can log into the Gateway to transfer funds into his new account (Account A) and recharge his smart card (Account B) with funds from Account A. First the user logs into the Gateway website, gets authenticated, and transfers funds to his new ban account (Account A). Next the user moves or recharges all or part of those funds in Account A to his Smart Card (actually moved to Account B).

Now the user is ready to make a purchase. The user visits a partner merchant, choose a product or service and clicks on the “Pay With Smart Card” button. The purchase experience is instantaneous. The user gets a confirmation. In the background, the Gateway performs a series of tasks. The Gateway confirms that the user was authenticated within the last XX minutes, and that the user had funds available in his smart card (Account B), moved the funds from Account B to merchant Account C, and passed the customer information to the merchant website.

Use-Cases—Transfer into Account:

The user seeds his new account by transferring funds from an external source. The source of the funds may be another bank account, a credit card cash advance, a wire, etc. The user logs into the Gateway website, authenticates and presses the “Transfer” button. The user chooses the amount and source of the transfer. The user is prompted to enter the information specific to that transfer. The user information requested will vary depending on the source of the funds to be transferred. In the detailed transfer event described below, the transfer source is an external bank account.

### Use-Cases—Recharging or Loading the Smart Card:

The user uses the Gateway server to load or recharge funds into the smart card from the bank account. This is called “Recharging the Smart Card.” First the user navigates to the Gateway server's website, logs in and chooses “Recharge My Smart Cards With Funds.” At this time, the Gateway may load an Active X to control communication between itself and the smart card reader. The user chooses the amount to recharge the card and presses “Recharge.” The Gateway server communicates with the user's smart card reader, via the Active X in the browser, to authenticate the user via the fingerprint sensor. The Gateway interfaces to the user Account A at the bank server to confirm that funds are available for recharging the card. The Gateway then moves the funds to Account B, to the user it shows it as recharging the value onto the card. The funds in the user Account B are the funds that are available “in the smart card” for purchases.

### Use-Cases—Making Online Purchases With Smart Card:

User navigates to a merchant website to make a purchase with his smart card. The merchant's website offers the option to “Pay With Your Smart Card.” The user chooses the “Pay With Smart Card” option. The merchant server interfaces to the Gateway to request a payment approval from the user's smart card. The merchant server may pass the user's IP address, as well as other info, to the Gateway so the Gateway can access the user's smart card for authentication and debiting.

The Gateway accesses the user's smart card (with Active X) and requests that the user authenticate his identify using the reader's fingerprint module. Upon authentication, the Gateway determines that the user has the funds available in his smart card (actual funds are in the user Account B). The Gateway then creates a Purchase Approval message and sends it to the merchant server. The merchant then releases the order for the newly purchased merchandise or service. In addition, the Gateway instructs the bank server to move the funds from the user's Account B to the Account C.

### SYSTEM DEFINITIONS

Account A: An actual bank account that holds the user's funds until the user “recharges” his smart card. Upon a “recharge”, the funds are moved from Account A to Account B.

Account B: An actual bank account that holds the amount “recharge” or loaded into the user's smart card. The funds are kept in Account B until the user makes an online purchase. In that case, funds are moved to Account C, or the merchant reconciliation account.

Account C: An actual bank account that holds the funds of purchased goods and services from partner merchants. The funds in Account C will eventually be reconciled with each merchant.

Bank: The partner bank where all funds are kept. The bank provides a server with API's for the Gateway to request and confirm movement of funds between each user Account A, Account B and merchant Account C.

Bank Server: A bank server which communicates with the Gateway server using API's. The Bank server, in turn, controls funds movement between the bank and external banks and funds movement between the accounts A, B and C.

Gateway Server: A dedicated server and application that coordinates a set of financial transaction between users' internal bank accounts (A, B and C).

Recharge: When the user requests that the Gateway move funds to his smart card. Conceptually, the user experiences his smart card as being “recharged” or funds are added to his account. In actuality, the funds are moved from the user Account A to the user Account B. The smart card is never loaded, or recharged, with any funds. When the user asks to see the funds in his smart card he is presented with the balance in his Account B.

Personal (Bank) Account: The user's account at his external personal bank.

Purchase: When a user uses this system to purchase merchandise/service from a partner merchant.

Transfer: Refers to a user transferring funds from his external Personal Account into his Account A. The user makes the request for a transfer through the GUI of the Gateway website.

### The Gateway:

The Gateway server consists of a group of modules with a central logic module called the Task Manager (112).

Task Manager (112) opens, processes and closes tasks. Common events include an Authentication, Transfer, Recharge and Purchase. The Task Manager 112) coordinates the necessary activities between the other modules to complete the task.

### Gateway Internal Components:

### Task Handler/GUI Server (110)

The Gateway module serves up the webpage GUI's for the user and accepts user text input. The Gateway website provides the GUI's include the Authentication page. Transfer page, Recharge page and Account Summary page. The GUI server may also provide a GUI at the merchant's Purchase webpage. The Task Handler (11) also accepts the user's form inputs from the GUI and hands off a formal task request to the Flow Manager (112).

### Task Flow Manager (112):

Contains the business logic of the entire Gateway system. This module opens, processes, logs and closes user-initiated Tasks. Common Tasks include “Authenticate,” “Transfer”, “Recharge” and “Purchase.” Each task has a beginning and an end, whether Success or Fail. The entire sequence of events for each task is logged into the Task Status Database (118).

This module processes user-initiated transactions by accepting a task request (with any user inputs) from the Handler (110), opening a new task thread, assigning a Task Number within the Task Status Database (118), requesting the steps of that specific steps from the Task Library (114) then following the steps to completion. Each task may require interfacing to the Authentication Module (132) to first confirm the user, checking user balances in the User Account Database (120), and requesting and confirming a funds transfer with the Bank Transaction Module (124). The Flow Manager continuously logs the status of each task in the Task Status Database (118).

### Task Library (114):

Maintains the steps, sequence, and input variables required for each task. It provides the Flow Manager (112) with the “recipe” for each type of task.

### User Status Database (116):

Maintains a database with the status of current users and the last time they were authenticated. This database is polled by the Task Manager (112) during a task sequence to determine if a user requires renewed authentication. If so, the Task Manager (112) INTERFACES TO THE Authentication Module (132), gets a confirmation of user authentication, then update the User Status Database (116).

### Task Status Database (118):

The module maintains the log and sequence of each task. Each step of every task is logged in the Task Status Database (118). The Task Manager (112) writes the status of each step of each task as it is occurring.

### User Account Database (120):

This database maintains all of the users' present balance in their Account A and Account B. this database also maintains the accounting for Transfers, Recharges and Purchases. In addition, each individual Transfer, Recharge or Purchase has an associated task log, for auditing.

The User Account Database (20) reflects the exact accounting that is in the Bank Server (128). The Gateway Task Manager (112) initiates all movement of funds to the Bank Transaction Module (124) so the accounting in the User Account Database (20) is legitimate and must always match the accounting at the Bank Server (128).

### Bank Transaction Module (124):

An interface module to the actual partner bank server. This module packages requests from the Task Manager (112) and hands off the request to the bank server. The bank server replies back to the Transaction Module (124) which in turn replies back to the Task Manager (112) with confirmation of the transaction. Upon confirmation, the Task Manager (112) updates the task sequence log for that specific task within the User Account Database.

### Bank Server (128):

This is bank server where funds are kept. The Gateway's Bank Transaction Module (124) interfaces to the Bank Server (128) to request/confirm the movement of funds.

### Authentication Module (132):

Upon a request from the Task Manager (112), the Authentication Module (132) interfaces to the user's biometric fingerprint module via our Active X (144) or similar control.

### Merchant Webpage (142):

The merchant webpage where the user chooses to “Pay With Smart Card.” The merchant webpage and server have been integrated with the Gateway. First, the merchant payment webpage has the functionality to interact to the user's Purchase Active X to pass the order info and present the order confirmation message. Refer to Gateway module called Active X (144). Second, the merchant server is able to receive a purchase confirmation message directly from the Gateway to the merchant server.

### Active X (144):

The user's browser is pre-loaded with several Active X controls. These Active X controls are preloaded into the user's browser at the time the reader software is installed. There are three active X loaded on the user's browser: Main Active X, Authenticate Active X and Purchase Active X.

### The Main Active X:

Communicates to the Gateway for the presentation of GUI's, calls the Authentication Active X, hands-off user text input, and requests to the Gateway the initiation of Tasks.

### Authenticate Active X:

Serves to authenticate the user at his PC using the smart card reader and fingerprint sensor. Provides the GUI for the authentication. The Authentication Active X interfaces to the reader/smart card and fingerprint reader to authenticate the user.

### Purchase Active X:

Coordinates the Purchase task. This Active X passes the purchase information from the merchant website to the Gateway during a Purchase Task. The Purchase Active X also receives the purchase confirmation message from the Gateway and passes this information to the merchant webpage (142) to display the “Order Confirmation” page to the user. Note that the official order confirmation is sent separately from the Gateway directly to the merchant server.

### Merchant Database (164):

Maintains a database of valid merchant ID's. This database is used during a Purchase task to validate that the merchant ID is valid and “in-good standing.”

### Task Descriptions:

A Task is defined as a sequence of steps that represent a Use-Case. These tasks involve user input (text, biometric), the Gateway application logic, and input from the merchant server. The three tasks described are Purchase, Recharge and Transfer.

### Assumptions to be a Valid User:

A task represents a Use-Case. There are several requirements for a fully-activated user, ready to make an online purchase at the partner merchant's website. A fully activated client is able to Transfer, Recharge and Purchase. For each user, the following assumptions are made:
Has a Windows PC, connected to Internet (DSL), with USB port available
Has the Smart Card/Biometric Reader
Has a valid Smart Card (proprietary)
Knows the URL of the Gateway website
Has reader drivers installed
Has Active X downloaded
Has his template fingerprint (s) already programmed into the smart card

### Purchase Event:

During a Purchase Event, the user purchases a product or service at a partner merchant's website using funds from his smart card. The result of a successful Purchase event are the following: the purchase amount is transferred from the user's smart card account (Account B) to the merchant account (Account C), the merchant receives a purchase confirmation message and the Ship-To address, and the user gets an order confirmation on the merchant webpage. The detailed steps of a Purchase Event are as follows:
1. User accesses merchant gateway (142) to choose a product or service.
2. User chooses product or service at merchant gateway (142) and clicks on “Pay With Smart Card.”
3. Purchase Active X (144) is passed the order information from the merchant webpage (142).
4. The Purchase Active X (144) prepares a purchase request for the Task Handler (110) and passes both the user and order information to the Task Handler (110). Within a Purchase request is included the following information: User ID, Merchant ID, Purchase Amount, Description.
5. the Task Handler (110) confirms that user is authenticated or has been authenticated in last XX minutes. Assume user is already authenticated. See Authentication Task sequence.
6. Task Handler (110) hands the Purchase request to the Task Manager (112).
7. Task Manager (112) requests the steps for a Purchase Event from the Transaction Library (114). Internal sequence in a Purchase Event include the following:
   a. Validate merchant
   b. Validate user
   c. Confirm user balance in Account B
   d. Transfer purchase amount from user account B to merchant account C
   e. Send merchant server the order confirmation and customer Ship-To information
   f. Confirm receipt by merchant of Ship-to information
   g. Inform user Active X that purchase is complete
   h. Provide merchant server with internal order confirmation
8. Task Manager (112) opens a new Purchase event in Task Status Database (118) and assigns that Purchase event a unique identifier.
9. Task Manager (112) begins the internal sequence of a Purchase Event (see 7a-7f)
10. Task Manager (112) interfaces to Merchant Database (164) and confirms the merchant ID from the purchase request. Assume merchant ID is a merchant in good standing.
11. Task Manager (112) logs success of step 7a in Task Status Database (118)
12. Task Manager (112) interfaces to User Account Database to validate the user ID and confirm that user has sufficient funds in Account A for the purchase. Assume valid user with sufficient balance.
13. Task Manager (112) logs success of step 7b, 7c in Task Status Database (118).
14. Task Manager (112) requests transfer of purchase amount from Account B to Account C at Bank Transaction Module (124).
15. Task Manager receives confirmation of transfer of funds from Bank Transaction Module (124). Assume transfer from Account B to Account C is successful.
16. Task Manager (112) updates the user balances in the User Account Database (120) to reflect the balances in Account B and Account C. Account B is debited by the purchase amount. Account C is credited with the purchase amount.
17. Task Manager (112) logs success of step 7d in Task Status Database (118). At this time, the Purchase request is executed.
18. Task Manager (112) sends the official “Purchase Confirmation” to the Merchant Server (168) including the user “Ship-To” information to fulfill the order, such as name and address. This is step 7e in the Purchase Event.
19. Merchant Server (168) replies back to Task Manager (112) to confirm that Ship-To information was received. This is step 7f in the Purchase Event.
20. Task Manager (112) logs the Success.
21. Task Manager (112) passes “Purchase Complete” message to Task Handler (110).
22. Task Handler (110) passes “Purchase Complete” message to user's Purchase Active X (144).
23. Purchase Active X (144) passes “Purchase Complete” message to merchant webpage (142).
24. Merchant webpage (142) displays the “Order Confirmation” GUI on the user's browser.

### Transfer Event:

During a Transfer, the user transfers external funds into his new account (Account A). The funds to be transferred originate from the user's bank account, a credit card cash advance, a money wire, etc. Funds are moved into the user's account (Account A) at the Bank Server (126). The Gateway application coordinates the entire Transfer Event. After the actual funds transfer is confirmed from the Bank Server (126).

Assumptions in this Transfer Event: (1) user is logged into the Gateway website, having been authenticated already. (2) User is transferring from a bank account (as opposed to a credit card advance or a wire).

The detailed steps of a Transfer Event are as follows:
1. User navigates his browser to the Gateway website to Transfer funds into his account and authenticates himself. Assume authentication is successful. See Authentication Task sequence.
2. User clicks on the “Transfer Funds” button at Gateway website.
3. Task Handler (110) presents the user with the GUI for Transfers.
4. User chooses the method of transfer. Assume the user chooses to transfer from his bank account.
5. User if prompted t enter the amount of transfer.
6. User is prompted to enter the bank account information including Routing Number, Bank Account Number and Bank Name.
7. User presses the “Submit” button in the Transfer webpage.
8. Task Handler (110) confirms that the user input data is the correct format.
9. Task Handler (110) takes the user inputs and prepares a Transfer request for the Task Manager. (112).
10. Task Manager (112) logs he Transfer request.
11. Task Manager (112) requests the steps for a Transfer Event from the Transaction Library (114).
12. Task Manager (112) opens a new Transfer event in Task Status Database (118) and assigns that Transfer event a unique identifier.
13. Task Manager (112) begins the internal sequence of a Transfer Event.
14. Task Manager (112) requests transfer of amount from external bank account to Account A at Bank Transaction Module (124).
15. Task Manager (112) receives confirmation of transfer of funds from Bank Transaction Module (124). Assume transfer from Account A to Account B is successful.
16. Task Manager (112) updates the user balances in the User Account Database (120) to reflect the new balances in Account A and Account B.
17. Task Manger (112) logs success of transfer in the Task Status Database (118). At this time, the transfer request is executed.
18. Task Manager (112) sends a “Transfer Confirmation” to the Task Handler (110).
19. Task Handler (110) prepares the webpage and presents a “Transfer Confirmed” to the user.

### Recharge Event:

During a Recharge, the user recharges his smart card (Account B) with funds from his new account (Account A). Funds “recharged” into the smart card can be used for online purchases at partner merchants. Note that actual funds are not loaded onto the smart card. When the user views his smart card balance, the Gateway webpage displays the balance in the Account B.

The Gateway application coordinates the entire Recharge Event. After the actual funds transfer is confirmed from the Bank Server (126).

Assumptions in this Transfer Event: (1) User is logged into the Gateway website, having been authenticated already.

The detailed steps of a Recharge Event are as follows:
1. User navigates his browser to the Gateway website to Recharge funds into his smart card (Account B) and authenticates himself. Assume authentication is successful. See Authentication Task sequence.
2. User clicks on the “Recharge Card” button at Gateway website.
3. Task Handler (110) presents the user with the GUI for Recharge.
4. User is prompted to enter the amount to recharge.
5. User presses the “Submit” button in the Recharge webpage.
6. Task Handler (110) prepares a Recharge request for the Task Manager (112).
7. Task Manager (112) logs the Recharge request.
8. Task Manger (112) requests the steps for a Recharge Event from the Transaction Library (114).
9. Task Manager (112) opens a new Recharge event in Task Status Database (118) and assigns that Recharge event a unique identifier.
10. Task Manager (112) begins the internal sequence of a Recharge event.
11. Task Manger (112) requests and receives the user balance in Account A from the User Account Database (120).
12. Task Manager requests transfer of amount from Account A to Account B at Bank Transaction Module (124).
13. Task Manger (112) receives confirmation of transfer of funds from Bank Transaction Module (124). Assume recharge from Account A to Account B is successful.
14. Task Manger (112) updates the user balances in the User Account Database (120) to reflect the new balances in Account A and Account B.
15. Task Manger (112) logs success of recharge in the Task Status Database (118). At this time the recharge request is executed.
16. Task Manager (112) sends a “Recharge Confirmation” to the Task Handler (110).
17. Task Handler (110) prepares the webpage and presents a “Recharge Confirmation” to the user.

### Authentication Event:

During a User Authentication, a two-factor authentication takes place. First, the Gateway confirms the smart card n the reader is correct. Second, the user's fingerprint is matched to a master fingerprint, stored on the smart card. In the description of this Authentication Event, the user is logging onto the Gateway website to make a Transfer of a Recharge. Assume that the user already has his master fingerprint template stored in his smart card.
1. User enters the URL of the Gateway website.
2. The Active X (144) in the user's browser recognizes the gateway URL.
3. The Active X (144) requests an Authentication Status for the user ID from the Task Handler (110).
4. The Task Handler (110) passes the Authentication Status request with the user ID to the Task Manger (112).
5. The Task Manager (112) initiates an Authentication event.
6. The Task Manager (112) polls the User Status Database (116) and receives the authentication status of the user. Assume the user requires authentication.
7. Task Manager (112) requests a user authentication from Authentication Module (132).
8. Authentication Module (132) interfaces to user's Active X (144) to display a GUI to request a fingerprint authentication.
9. User's Active X (144) instructs user to swipe their fingerprint.
10. Active X (144) interfaces to Reader (156) to request a fingerprint match.
11. Reader (156) accepts the user's fingerprint from the fingerprint sensor (160) and presents it to the smart card.
12. Smart card (162), reader (156), fingerprint sensor (160) and user PC work to perform the “Match-On-Card.” This may be a “behind-the-scenes” method, proprietary to the smart card/reader manufacturer.
13. Assume that fingerprint matches the user's master fingerprint after the “Match-On-Card” sequence.
14. User's Active X Control (144) passes Authentication confirm to Authentication Module (132).
15. Authentication Module (132) interfaces to Task Manager (112) to confirm user authentication.
16. Task Manger (112) updates the User Status Database (116) with the new user authentication status.
17. Task Manager (112) sends a “user authenticated” confirmation to the Task Handler (110).
18. Task Handler (110) presents the Gateway website to the user in a “Logged In” status.

### Miscellaneous:

The communication between the Gateway and the user Active X is done in a secure SSL environment. Additional encryption techniques are employed to ensure the integrity of the data communication between the Gateway and its external components.

The matching of the fingerprint is performed on an integrated smart card reader with a fingerprint sensor. The actual fingerprint match is done within the smart card, called “Match-On-Card.” This method may be proprietary to the reader manufacturer.

An important variation of the invention may be described as a computer-based system for securely transferring funds between a first party and a second party, the computer based system comprising: A gateway server that is internet enabled and owned and managed by a third party, such as a bank or credit card clearing servicer. It also should have a computer terminal accessible to a first party having, inter alia, a smart card reader and a biometric reader and being connectable to the internet. This typically would be a home personal computer with commonly available peripherals. To use the system, the first party (typically a consumer of goods or services) transfers a pre-selected value of funds from an external bank account owned by the first party through the gateway server to a first bank account owned by the first party. Essentially this brings in funds from outside the system into the system governed and monitored by the third party. Said first bank account is held at a partner bank to facilitate easy transfers. The gateway server records in memory the transfer to independently account the funds held in said first bank account. When making a purchase the first party may then instruct the gateway server, over the internet, to transfer a pre-selected value of funds from said first bank account to a second bank account owned by the first party and the gateway server records in memory the transfer to independently account the funds in said first bank account and said second bank account. The second bank account is now charged with funds and other bank accounts are not exposed or open to the transaction. Said second bank account is held at said partner bank for easy, uncomplicated transfers. The first party has a smart card that is compatible with said smart card reader. When the first party wishes to make a purchase from a second party (for example, an online merchant) on the internet the first party accesses the gateway server through said computer terminal the internet and logs on the gateway server proving the identity of the first party by providing both physical smart card verification data and biometric verification data to the gateway server and then the first party places a secure order with the second party over the internet and elects to pay using said computer-based system. By the first party having both the physical smart card and obviously having the natural biometric data the likelihood of fraud is reduced. The second party then queries said gateway server over the internet to determine if the first party is positively identified, has logged onto the server within a predetermined time frame (for example, in the past five or ten minutes or as the system dictates) and has sufficient funds in said second bank account to cover a purchase value of said purchase. If said second bank account has sufficient funds and the first party has been positively identified and the first party has logged onto the gateway server within said predetermined time frame then the gateway server transfers funds in the amount of said purchase value from said second bank account to a third bank account owned by the second party and the gateway server records in memory the transfer to independently account the funds in said second bank account and said third bank account. Said third bank account is held at said partner bank. The funds can then be transferred out of the system from the second party's third bank account to another outside bank account owned by the second party or to other destinations.

In a variation the system can be further characterized in that said biometric reader reads any of a fingerprint, eye, voice, palm or face. Of course any data unique to a particular individual could be used to help positively identify that individual.

In another variation may be further characterized in that the transfer from said second bank account to said third bank account can be reversed to chargeback funds from the third bank account to the second bank account. This may become important if the second party is refunding money back to the first party. In yet another variation, the system can be further characterized in that when funds are transferred between the second bank account and the third bank account then either or both the first party and the second party are notified of the transfer by said third party. This could be by text message, mail, email or other commonly available means of communication. This provides a tangible receipt that the transaction has been completed. This can also help reduce fraud by providing near-real-time alerts to activity.

In another variation can be further characterized in that said smart card has recorded into integral memory biometric information unique to said first party. In other words the data outputted from the biometric reader can be saved on the smart card. This typically is encrypted for security. This provides a feature so that the verification of the first party can begin at the first party's computer terminal. By having the smart card and the secured data it contains at the same location as the natural body part read by the biometric reader security is enhanced. The foregoing description conveys the best understanding of the objectives and advantages of the present invention. Different embodiments may be made of the inventive concept of this invention. It is to be understood that all matter disclosed herein is to be interpreted merely as illustrative, and not in a limiting sense.

A closed value transfer system for online commerce using a Smart Card and a USB Biometric Smart Card and Fingerprint Reader, for making quick, private and secure online purchases.

What is claimed is:

1. A computer-based system for securely transferring funds between a first party and a second party, the computer based system comprising:
A gateway server that is internet enabled and owned and managed by a third party;
A computer terminal accessible to a first party having, inter alia, a smart card reader and a biometric reader and being connectable to the internet;
Wherein, the first party transfers a pre-selected value of funds from an external bank account owned by the first party through the gateway server to a first bank account owned by the first party;
Said first bank account is held at a partner bank;
The gateway server records in memory the transfer to independently account the funds held in said first bank account;
The first party may then instruct the gateway server over the internet to transfer a pre-selected value of funds from said first bank account to a second bank account owned by the first party and the gateway server records in memory the transfer to independently account the funds in said first bank account and said second bank account;
Said second bank account is held at said partner bank;
The first party having a smart card that is compatible with said smart card reader;
When the first party wishes to make a purchase from a second party on the internet the first party accesses the gateway server through said computer terminal the internet and logs on the gateway server proving the identity of the first party by providing both physical smart card verification data and biometric verification data to the gateway server and then the first party places a secure order with the second party over the internet and elects to pay using said computer-based system;
The second party queries said gateway server over the internet to determine if the first party is positively identified, has logged onto the server within a predetermined time frame and has sufficient funds in said second bank account to cover a purchase value of said purchase;
If said second bank account has sufficient funds and the first party has been positively identified and the first party has logged onto the gateway server within said predetermined time frame then the gateway server transfers funds in the amount of said purchase value from said second bank account to a third bank account owned by the second party and the gateway server records in memory the transfer to independently account the funds in said second bank account and said third bank account;
Said third bank account is held at said partner bank.

2. A computer-based system for securely transferring money between a first party and a second party as disclosed in claim 1, further characterized in that said biometric reader reads any of a fingerprint, eye, voice, palm or face.

3. A computer-based system for securely transferring money between a first party and a second party as disclosed in claim 1, further characterized in that the transfer from said second bank account to said third bank account can be reversed to chargeback funds from the third bank account to the second bank account.

4. A computer-based system for securely transferring money between a first party and a second party as disclosed in claim 1, further characterized in that when funds are transferred between the second bank account and the third bank account then either or both the first party and the second party are notified of the transfer by said third party.

5. A computer-based system for securely transferring money between a first party and a second party as disclosed in claim 1, further characterized in that said smart card has recorded into integral memory biometric information unique to said first party.
